(19) United States
(12) Patent Application Publication
(10) Pub. No.: US 2015/0188996 A1
(43) Pub. Date: Jul. 2, 2015

(54) VIRTUAL OBJECT GENERATING APPARATUS AND METHOD FOR DATA DISTRIBUTION SERVICE (DDS) COMMUNICATION IN MULTIPLE NETWORK DOMAINS

(71) Applicant: ELECTRONICS AND TELECOMMUNICATIONS RESEARCH INSTITUTE, Daejeon (KR)

(72) Inventors: Je Man PARK, Seoul (KR); Soo Hyung LEE, Daejeon (KR); Hyung Kook JUN, Daejeon (KR); Kyung Il KIM, Daejeon (KR); Kyeong Tae KIM, Daejeon (KR); Yong Yeon KIM, Daejeon (KR); Won Tae KIM, Asan-si (KR)

(21) Appl. No.: 14/570,032

(22) Filed: Dec. 15, 2014

(30) Foreign Application Priority Data
Dec. 26, 2013 (KR) 10-2013-0164424
Mar. 28, 2014 (KR) 10-2014-0036984

(51) Int. Cl. H04L 29/08; H04L 12/24

(52) U.S. Cl. CPC H04L 67/10; H04L 41/50

(57) ABSTRACT

Provided herein is a method and apparatus for generating a virtual object for DDS (Data Distribution Service) communication in multiple network domains, the apparatus including: a communicator for receiving EDP (Endpoint Discovery Protocol) information on a remote Endpoint from a remote network domain separated physically or logically; and a virtual object generator for matching the EDP information on the remote Endpoint and information included in the remote network domain prestored in a database, and for generating a virtual object corresponding to the remote Endpoint.

### CROSS-REFERENCE TO RELATED APPLICATIONS

The present application claims priority to Korean patent application numbers 10-2013-0164424, filed on Dec. 26, 2013 and 10-2014-0036984, filed on Mar. 28, 2014, the entire disclosure of which is incorporated herein in its entirety by reference.

### BACKGROUND

1. Field of Invention

Various embodiments of the present invention relate to a communication apparatus, and more particularly, to a communication apparatus for a DDS in multiple network domains.

2. Description of Related Art

A data-centric communication method is suitable for cases where participants in a network frequently exchange data of a same type. Furthermore, when there are a lot of participants, and registering and deregistering processes are conducted dynamically, rather than a server-client type data exchange method of finding a counterpart with whom to exchange data in an application program and connecting with the counterpart, a data exchange method of publishing/subscribing the data that one wants to exchange without recognition of a counterpart is more effective.

Therefore, the OMG (Object Management Group) which is an international organization defined a DDS (Data Distribution Service), a standard communication middleware which aims at data-centric real time data distribution.

In DDS communication, publishers who publish data and subscribers who subscribe data may set one network domain and communicate a data sample of a type that the publishers and subscribers promised with each other in a multicast method.

However, in DDS communication, publishers and subscribers in a same network domain may communicate with each other, but it is impossible for publishers and subscribers in different domains to communicate with each other. In other words, in DDS communication, without a router that supports the multicast communication method between multiple network domains that are physically or logically separated, communication cannot be made.

Meanwhile, a conventional DDS router may directly perform communication between network domains or perform communication using an intermediary for DDS communication.

A direct communication method is a method where endpoints, that is, writers or readers in each network domain exchange a control signal and data directly with one another.

However, such a direct communication method has a problem that is cannot satisfy the QoS (Quality of Service) required by an endpoint depending on the state of a via network.

Furthermore, a via network uses a TCP (Transfer Control Protocol) communication to secure reliability, whereas the DDS standard uses a UDP (User Datagram Protocol) communication. Therefore, the direct communication method has a problem that as a DDS router must be designed such that it may perform TCP communication between endpoints, it violates the DDS standard.

A communication method using an intermediary is a method of replaying data using an intermediary. That is, the communication method using an intermediary is a method of actually generating an endpoint in an intermediary and collecting a control signal and data of a local network domain, and distributing the collected control signal and data to an endpoint of a remote network domain.

However, such a communication method using an intermediary has a problem of increasing the overhead in the intermediary in the case of a large scale network.

Furthermore, in such a communication method that using an intermediary, the number of endpoints generated in the intermediary increases by a multiple of the number of network domains, thereby resulting in a sharp increase of control signals and data.

Therefore, it is necessary to conduct studies on DDS routers for DDS communication in multiple network domains.

### SUMMARY

A purpose of various embodiments of the present invention is to resolve the aforementioned problems, that is, to provide a virtual object generating apparatus for DDS communication in multiple network domains.

Another purpose of various embodiments of the present invention is to provide a virtual object generating method for DDS communication in multiple network domains.

According to an embodiment of the present invention, there is provided a virtual object generating apparatus for DDS (Data Distribution Service) communication in multiple network domains, the apparatus including a communicator for receiving EDP (Endpoint Discovery Protocol) information on a remote Endpoint from a remote network domain separated physically or logically; and a virtual object generator for matching the EDP information on the remote Endpoint and information included in the remote network domain prestored in a database, and for generating a virtual object corresponding to the remote Endpoint.

Herein, the information included in the remote network domain may include PDP (Participant Discovery Protocol) GUID (Globally Unique Identifier) information and Endpoint GUID information on the remote network domain.

Herein, the virtual object generator may search the PDP GUID information based on the EDP information on the remote Endpoint, search the Endpoint GUID information based on a result of the search and generate a virtual object corresponding to the remote endpoint.

Herein, the virtual object generator may generate a virtual object corresponding to a remote Writer of the remote network domain, when the EDP information on the remote Endpoint is cache information stored in a HistoryCache of a remote BuiltinPublisher of the remote network domain.

Herein, the virtual object generator may generate a virtual object corresponding to a remote Reader of the remote network domain, when the EDP information on the remote Endpoint is cache information stored in a HistoryCache of a remote BuiltinSubscriber of the remote network domain.

Herein, virtual object corresponding to the remote Endpoint may be a virtual object of the remote Endpoint that shares a same topic with an endpoint of a DDS.

According to an embodiment of the present invention, there is provided a virtual object generating method for DDS (Data Distribution Service) communication in multiple network domains, the method including receiving EDP (Endpoint Discovery Protocol) information on a remote Endpoint from a remote network domain separated physically or logically; and matching the EDP information on the remote Endpoint and information included in the remote network domain prestored in a database, and generating a virtual object corresponding to the remote Endpoint.

Herein, the information included in the remote network domain may include PDP (Participant Discovery Protocol) GUID (Globally Unique Identifier) information and Endpoint QUID information on the remote network domain.

Herein, the generating a virtual object corresponding to the remote endpoint may search the PDP GUID information based on the EDP information on the remote Endpoint, search the Endpoint GUID information based on a result of the search, and generate a virtual object corresponding to the remote Endpoint.

Herein, the generating a virtual object corresponding to the remote Endpoint may generate a virtual object corresponding to a remote Writer of the remote network domain, when the EDP information on the remote Endpoint is cache information stored in a HistoryCache of a remote BuiltinPublisher of the remote network domain.

Herein, the generating a virtual object corresponding to the remote Endpoint generates a virtual object corresponding to a remote Reader of the remote network domain, when the EDP information on the remote Endpoint is cache information stored in a HistoryCache of a remote BuiltinSubscriber of the remote network domain.

Herein, the virtual object corresponding to the remote Endpoint may be a virtual object of the remote Endpoint that shares a same topic with an endpoint of a DDS.

The aforementioned embodiments of the present invention provide an effect of performing DDS communication between an endpoint included in a network domain with a virtual object corresponding to an endpoint of a remote network domain thereby satisfying QoS (Quality of Service) required in the endpoint.

The aforementioned embodiments of the present invention also provide an effect of performing DDS communication between endpoints configured in different network domains without violating the DDS standard.

Furthermore, the aforementioned embodiments of the present invention also provide an effect of relaying data without actually generating an endpoint in a virtual object generating apparatus, thereby reducing the load that may occur in a router, and reducing control signals and data such as PDP and EDP.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a block diagram illustrating a main configuration of a DDS according to an embodiment of the present invention;

FIG. 2 is a block diagram illustrating an entirety of a system for DDS communication in multiple network domains according to an embodiment of the present invention;

FIG. 3 is a block diagram illustrating a virtual object generating apparatus for DDS communication in multiple network domains according to an embodiment of the present invention;

FIG. 4 is a view illustrating a process of exchanging PDP information and EDP information between DDS routers including a virtual object generating apparatus according to an embodiment of the present invention;

FIG. 5 is a view for explaining DDS communication using a virtual object in multiple network domains according to an embodiment of the present invention;

FIG. 6 is a flowchart illustrating a process of performing DDS communication through generating a virtual object in multiple network domains according to an embodiment of the present invention;

FIG. 7 is a flowchart illustrating a process of generating a virtual object corresponding to a remote endpoint in multiple network domains according to an embodiment of the present invention;

FIG. 8 is a flowchart illustrating a process of generating a virtual object corresponding to a remote writer in multiple network domains according to an embodiment of the present invention; and

FIG. 9 is a flowchart illustrating a process of generating a virtual object corresponding to a remote reader in multiple network domains according to an embodiment of the present invention.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘a first’, ‘a second’, ‘A’, and ‘B’ may be used to describe various components, but they should not be construed as limited to those various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected/accessed’ represents that one component is directly connected/accessed to another component or indirectly connected/accessed through another component.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Unless defined otherwise, the terms used in this specification including technical and scientific terms have the same meanings as those generally comprehended by those skilled in the related art. The terms defined in generally used dictionaries must be construed as having the same meanings in the context of related technologies, and unless defined otherwise, must not be construed as having ideal or excessively formal meanings.

Hereinbelow, a virtual object generating apparatus for DDS communication in multiple network domains according to an embodiment of the present invention will be explained with reference to the attached drawings.

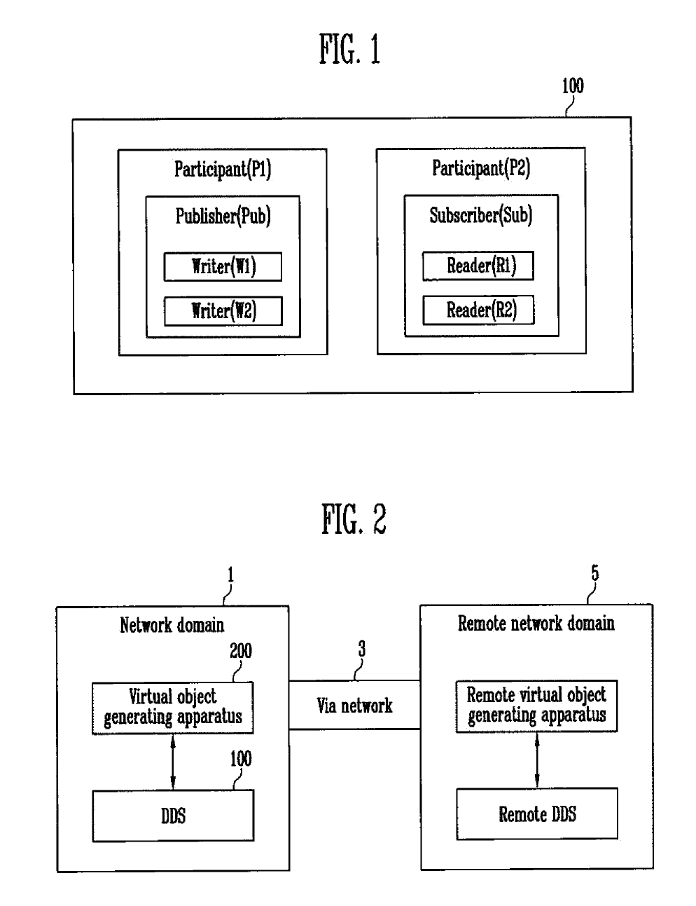

FIG. 1 is a block diagram illustrating a main configuration of a DDS according to an embodiment of the present invention.

Referring to FIG. 1, the main configuration 100 according to an embodiment of the present invention may include Participants P1 and P2, a Pub (publisher), a Sub (Subscriber), Endpoints W1, W2, R1, and R2, and HistoryCache (not illustrated). Herein, the Endpoints W1, W2, R1, and R2 may include Writers W1 and W2 or Readers R1 and R2.

The Participants P1 and P2 are subjects participating in a network, and for an application to subscribe to a domain, one or more participants P1 and P2 may be generated. Furthermore, the Participants P1 and P2 may perform communication with the Participants having a same topic using a multicast method or broadcast method.

Herein, a topic is the type of data that the Pubs (publishers) and Subs (subscribers) exchange with each other that will be explained hereinbelow, and the topic may be defined in various ways according to a data message standard for the purpose of data-centric real time data distribution.

Furthermore, the Participants P1 and P2 may include at least one of the Pubs (publishers) who provide data and the Subs (subscribers) who receive data. Herein, there may be one or more Pubs (publishers) and Subs (subscribers).

The Pubs (publishers) are objects in charge of publishing data, and these Pubs (publishers) may include one or more Writers W1 and W2. Furthermore, when an application writes a topic in a domain using the Writers W1, W2, the Pubs (publishers) may provide the topic to the Subs (subscribers) to be explained hereinbelow.

The Subs (subscribers) are objects in charge of subscribing data, and these Subs (subscribers) may include one or more Readers R1 and R2. Furthermore, the Subs may receive a topic from the Pubs (publishers), and the received topic may be provided to the Readers R1 and R2. Furthermore, an application may read the topic received using the Readers R1 and R2.

The HistoryCache (not illustrated) is a History Buffer that maintains a CacheChange class received in the Writers W1 and W2 and Readers R1 and R2, and the HistoryCache may be matched one by one to each of the Writers WI and W2, and Readers R1 and R2. Herein, The CacheChange class maintains the data to be actually transmitted and data information. Furthermore, the HistoryCache (not illustrated) may include HistoryCache of a BuiltinPublisher and HistoryCache of BuiltinSubscriber.

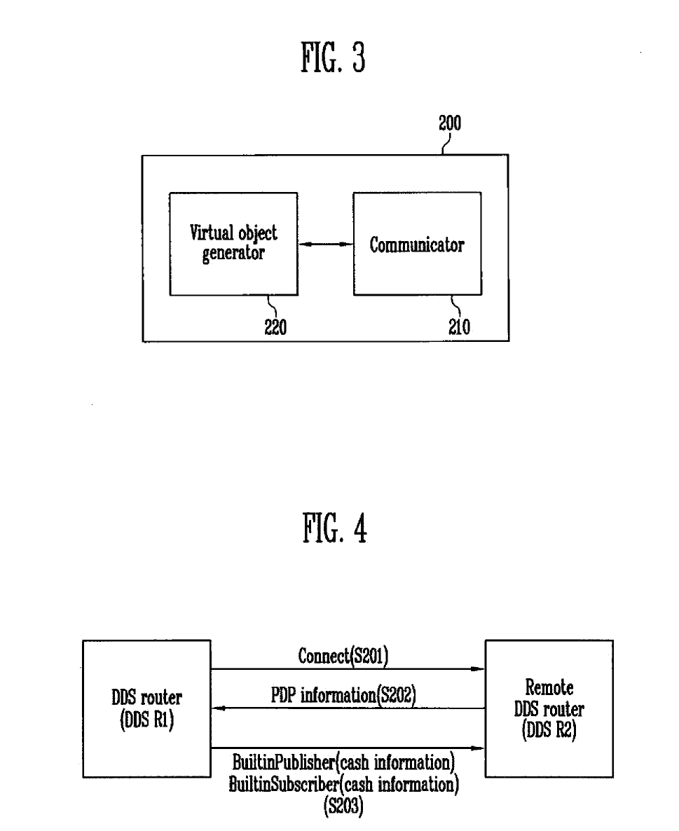

FIG. 2 is a block diagram illustrating an entirety of a system for DDS communication in multiple network domains according to an embodiment of the present invention.

Referring to FIG. 2, the entirety of a system for DDS communication in multiple network domains according to an embodiment of the present invention includes a plurality of network domains and a via network.

The plurality of network domains may be configured as being two network domains as illustrated in FIG. 2 for simplicity of explanation, but should not be construed as limited to two network domains, and may thus be configured as being three of more network domains.

The plurality of network domains may include a network domain 1 and a remote network domain 5.

Herein, for simplicity of explanation, ‘remote’ means that the remote network domain 5 is located such that it is separated from the network domain 1 physically and logically.

Herein, a domain is a data sharing region. To an application belonging to a domain, a logically separated virtual network may be provided.

Furthermore, the network domain 1 and the remote network domain 5 may be connected through the via network 3, and information included in the network domains 1 and 5 may be transmitted through this via network 3.

Herein, the via network 3 may be a wired communication network, wireless communication network, or a combination of a wired communication network and a wireless communication network. Herein, the via network 3 may use a TCP (Transmission Control Protocol) communication method.

Furthermore, the network domain 1 and remote network domain 5 may each include a virtual object generating apparatus 200 and a DDS 100. Herein, the remote DDS and the DDS 100 may have the same configuration and functions, and the remote virtual object generating apparatus and the virtual object generating apparatus 200 may have the same configuration and functions.

The virtual object generating apparatus 200 may match EDP (Endpoint Discovery Protocol) information on a remote Endpoint information received from the remote network domain 5 and information included in the remote network information prestored in a database, and generate a virtual object corresponding to the remote Endpoint.

The DDS 100 may be connected to the virtual object generating apparatus 200. Furthermore, an Endpoint of the DDS 100 may perform DDS communication with the virtual object corresponding to a remote Endpoint generated in the virtual object generating apparatus 200.

FIG. 3 is a block diagram illustrating a virtual object generating apparatus for DDS communication in multiple network domains according to an embodiment of the present invention.

Referring to FIGS. 2 and 3, the virtual object generating apparatus 200 according to an embodiment of the present invention includes a communicator 210 and a virtual object generator 220.

Herein, the virtual object generating apparatus 200 may be included in a DDS router.

The communicator 210 may be connected through a via network to a remote virtual object generating apparatus of a remote network domain 5 that is separated physically or logically. Furthermore, the communicator 210 may receive EDP information on a remote Endpoint from the remote virtual object generating apparatus.

Furthermore, the communicator 210 may be located inside the virtual object generating apparatus 200 as illustrated in FIG. 3, but should not be construed as limited to being located inside the virtual object generating apparatus 200, and may thus be located anywhere as long as it may transmit/receive data.

The virtual object generator 220 may be connected to the communicator 210. Furthermore, the virtual object generator 220 may receive EDP information on a remote Endpoint from the communicator 210.

Furthermore, the virtual object generator 220 may match EDP information on the remote Endpoint received with information included in the remote network domain 5 prestored in a database. Furthermore, the virtual object generator 220 may generate a virtual object corresponding to the remote Endpoint according to a result of the matching.

Herein, the virtual object corresponding to the remote Endpoint may be a virtual object of the remote Endpoint that shares a same topic as an Endpoint of the DDS 100. That is, a virtual object that may be generated is only one that corresponds to a remote Endpoint that requires DDS communication with an Endpoint of the DDS 100 or one that corresponds to an Endpoint that requires DDS communication with a remote Endpoint.

A database may be included in the virtual object generator 220, but should not be construed as limited to be included in the virtual object generator 220. The database may be in any position as long as it may store, and transmit/receive data.

By way of an example, the database may store a cache stored in a HistoryCache of the DDS 100. Herein, the database may receive cache information from the HistoryCache of a BuiltinPublisher. Herein, the database may receive cache information stored in the HistoryCache of the BuiltinSubscriber of the DDS 100 and store the received cache information. By way of another example, the database may be a HistoryCache of the DDS 100.

Furthermore, the database may store information included in the remote network domain 5. Herein, the information stored in the remote network domain 5 may include PDP (Participant Discovery Protocol) information and EDP information on the remote network domain 5.

More specifically, the PDP information may include domain participating information of a participant, survival information of a participant, information for searching a participant, and PDP GUID (Globally Unique Identifier) for identifying participants in a domain.

More specifically, the EDP information may include Endpoint information, topic information, and Endpoint GUID information for identifying Endpoints in a domain.

The virtual object generator 220 may search PDP GUID information on the remote network domain 5 prestored in the database based on the EDP information on the remote Endpoint, and generate a first search result according to a result of the search.

Furthermore, the virtual object generator 220 may search Endpoint GUID information on the remote network domain 5 prestored in the database based on the first search result, and generate a second search result according to a result of the search.

Furthermore, the virtual object generator 220 may generate a virtual object corresponding to the remote Endpoint according the second search result.

By way of an example, when Endpoint GUID information on the remote network domain 5 exists in the database, the virtual object generator 220 may use a virtual object corresponding to the remote Endpoint pregenerated and prestored in the database.

By way of another example, when Endpoint GUID information on the remote network domain 5 does not exist in the database, the virtual object generator 220 may generate a virtual object corresponding to the remote Endpoint. Furthermore, the virtual object generator 220 may store information on the generated virtual object corresponding to the remote Endpoint in the database.

When the EDP information on the remote Endpoint is cache information stored in the HistoryCache of the remote BuiltinPublisher of the remote network domain 5, the virtual object generator 220 may search PDP GUID information on the remote network domain 5 prestored in the database based on the cache information stored in the HistoryCache of the remote BuiltinPublisher, and generate a third search result according to a result of the search.

Furthermore, the virtual object generator 220 may search Endpoint GUID information on the remote network domain 4 prestored in the database based on the third search result, and generate a fourth search result according to a result of the search.

Furthermore, the virtual object generator 220 may generate a virtual object corresponding to a remote Writer of the remote network domain 5 according to the fourth search result.

By way of an example, when Endpoint GUID information on the remote network domain exists in the database, the virtual object generator 220 may use a virtual object corresponding to a remote Writer previous generated and prestored in the database.

By way of another example, when Endpoint GUID information on the remote network domain 5 does not exist in the database, the virtual object generator 220 may generate a virtual object corresponding to the remote Writer. Furthermore, the virtual object generator 220 may store information on the generated virtual object corresponding to the remote Writer in the database. Furthermore, the virtual object generator 220 may compare the virtual object corresponding to the remote Writer and cache information stored in the HistoryCache of the BuiltSubscriber and connect to matching Subscriber information.

When EDP information on the remote Endpoint is cache information stored in the HistoryCache of the remote BuiltinSubscriber of the remote network domain 5, the virtual object generator 220 may search PDP GUID information on the remote network domain 5 prestored in the database based on the cache information stored in the HistoryCache of the remote BuiltinSubsciber, and generate a fifth search result according to a result of the search.

Furthermore, the virtual object generator 220 may search Endpoint GUID information on the remote network domain 5 prestored in the database based on the fifth search result, and generate a sixth search result according to a result of the search.

Furthermore, the virtual object generator 220 may generate a virtual object corresponding to a remote Reader of the remote network domain 5 according to the sixth search result.

By way of an example, when Endpoint GUID information on the remote network domain 5 exists in the database, the virtual object generator 220 may use a virtual object corresponding to a remote Reader pregenerated and prestored in the database.

By way of another example, when Endpoint GUID information on the remote network domain 5 does not exist in the database, the virtual object generator 220 may generate a virtual object corresponding to the remote Reader. Furthermore, the virtual object generator 220 may store information on the generated virtual object corresponding to the remote Reader in the database. Furthermore, the virtual object generator 220 may compare the virtual object corresponding to the remote Reader with cache information stored in the HistoryCache of the BuiltinCache, and connect to matching Publisher information.

As aforementioned, a virtual object generating apparatus for DDS communication in multiple network domains according to an embodiment of the present invention may generate a virtual object corresponding to an Endpoint of a remote network domain, and perform DDS communication between the generated virtual object and an Endpoint included in a network domain.

Therefore, unlike conventional direct communication methods wherein Endpoints configured in different network domains directly perform DDS communication through a via network, a virtual object generating apparatus according to an embodiment of the present invention performs DDS communication between network domains using a virtual object generating apparatus, thereby satisfying QoS (Quality of Service) required by Endpoints. Furthermore, it becomes possible to perform DDS communication between the Endpoints configured in different network domains without violating the DDS standards.

Furthermore, unlike conventional communication methods using intermediaries where Endpoints are actually generated in an intermediary and data is relayed, a virtual object generating apparatus according to an embodiment of the present invention relays data without actually generating an Endpoint, thereby reducing the load occurring in a router, and significantly reducing control signals and data regarding PDP and EDP.

FIG. 4 is a view illustrating a process of exchanging PDP information and EDP information between DDS routers including a virtual object generating apparatus according to an embodiment of the present invention.

Referring to FIG. 4, a DDS router (DDS R1) according to an embodiment of the present invention may include the aforementioned virtual object generating apparatus.

Hereinbelow, the DDS router (DDS R1) is referred to as an accessing router, and a remote DDS router (DDS R2) is referred to as a router being accessed.

First of all, the DDS router (DDS R1) may access the remote DDS router (DDS R2) (S201).

Then, the remote DDS router (DDS R2) may provide its PDP GUID information to the DDS router (DDS R1) (S202).

Herein, the PDP GUID information may include information for identifying routers, and information for determining the order of priority of the routers. That is, unless the POP GUID information is exchanged, it is impossible to know which router accessed when the routers accessed at the same time, nor is it possible to determine the order of priority of the routers.

Herein, the PDP GUID information may include reference GUID information for generating a virtual object, that is, a virtual Writer and virtual Reader.

Furthermore, after the DDS router (DDS R1) is allocated with new PDP GUID information (S202), the DDS router (DOS R1) may transmit all cache information stored in its HistoryCache of the BuiltinPublisher and BuiltinSubscriber to a remote DDS router (DDS R2) (S203).

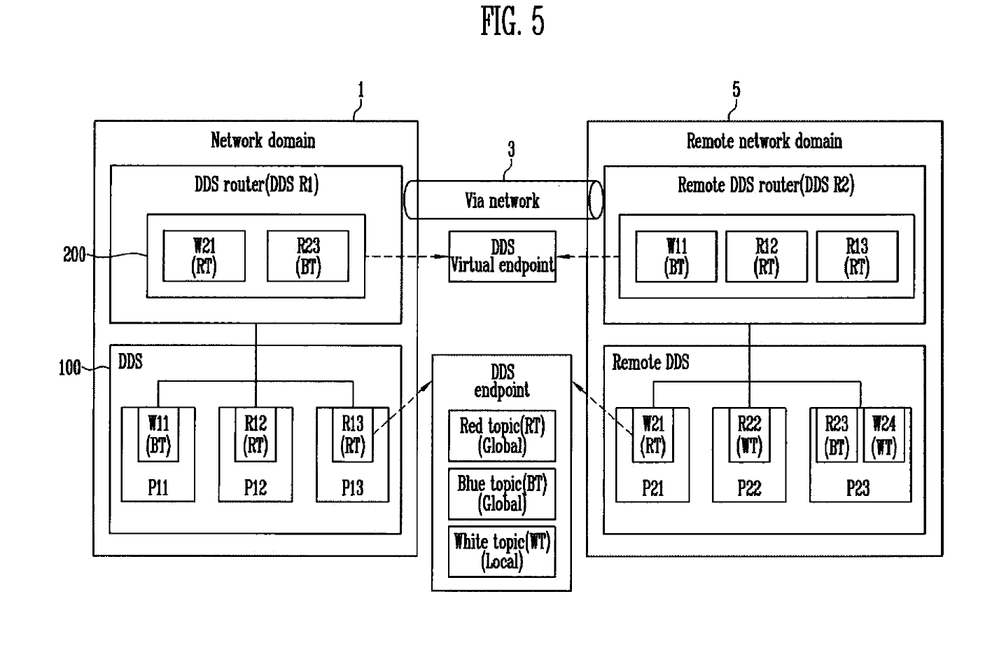

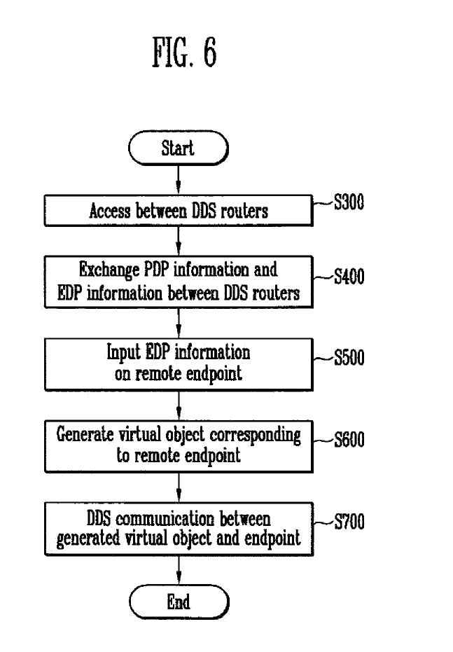

FIG. 5 is a view for explaining DDS communication using a virtual object in multiple network domains according to an embodiment of the present invention.

Referring to FIG. 5, a network domain 1 may include a DDS 10 and DDS router (DDS R1), and a remote network domain 5 may include a remote DDS and remote DDS router (DDS R2). Herein, the DDS router (DDS R1) may include a virtual object generating apparatus 200, and the remote DDS router (DDS R2) may include a remote virtual object generating apparatus.

The DDS 100 may include three Participants P11, P12, and P13, each of the Participants P11, P12, and P13 including an Endpoint W11, R12, and R13, respectively. Herein, the Participant P11 may include a Writer W11, and the Writer W11 may include a BT (Blue Topic). Furthermore, the Participant P12 may include a Reader R12, and the Reader R12 may include an RT (Red Topic). Furthermore, the Participant P13 may include a Reader R13, and the Reader R13 may include an RT (Red Topic).

The remote DDS may include three Participants P21, P22, and P23. Herein, the Participant P21 may include a Writer W21, and the Writer W21 may include an RT (Red Topic). Furthermore, the Participant P22 may include a Reader R22, and the Reader R22 may include a WT (White Topic). Furthermore, the Participant P23 may include a Reader R23 and a Writer W24, and the Reader R23 may include a BT (Blue Topic), and the Writer W24 may include a WT (White Topic).

The DDS router (DDS R1) may generate a virtual object corresponding to the remote Endpoints W21, R22, R23, and W24 of the remote network domain.

The remote DDS router (DDS R2) may generate a virtual object corresponding to the Endpoints W11, R12, and R13 of the network domain 1.

Herein, the virtual objects that may be generated by the DDS router (DDS R1) are only those corresponding to the remote Endpoints that perform DDS communication with the Endpoints of the network domain 1. Likewise, the virtual objects that may be generated by the remote DDS router (DDS R2) are only those corresponding to the Endpoints that perform DDS communication with remote Endpoints of the remote network domain 5.

That is, the DDS router (DDS R1) and the remote DDS router (DDS R2) may only generate a virtual object corresponding to an Endpoint that shares a same topic BT, RT.

Herein, the DDS router (DDS R1) may generate a virtual object corresponding to the Writer W21 having an RT (red topic) and the Reader R23 having a BT (blue topic). Herein, the remote DDS router (DDS R2) may generate a virtual object corresponding to the Reader R12 and Reader R13 having an RT (red topic) and the Writer W11 having a BT (blue topic).

Furthermore, a virtual object may not be generated for the R22 and Writer W24 having a WT (white topic) included in the remote network domain 5 only.

Hereinbelow, a virtual object generating method for DDS communication in multiple network domains according to an embodiment of the present invention will be explained with reference to the attached drawings. Especially, explanation on parts that are the same as in a virtual object generating apparatus for DDS communication in multiple network domains according to an embodiment of the present invention as aforementioned will be omitted for simplicity of explanation.

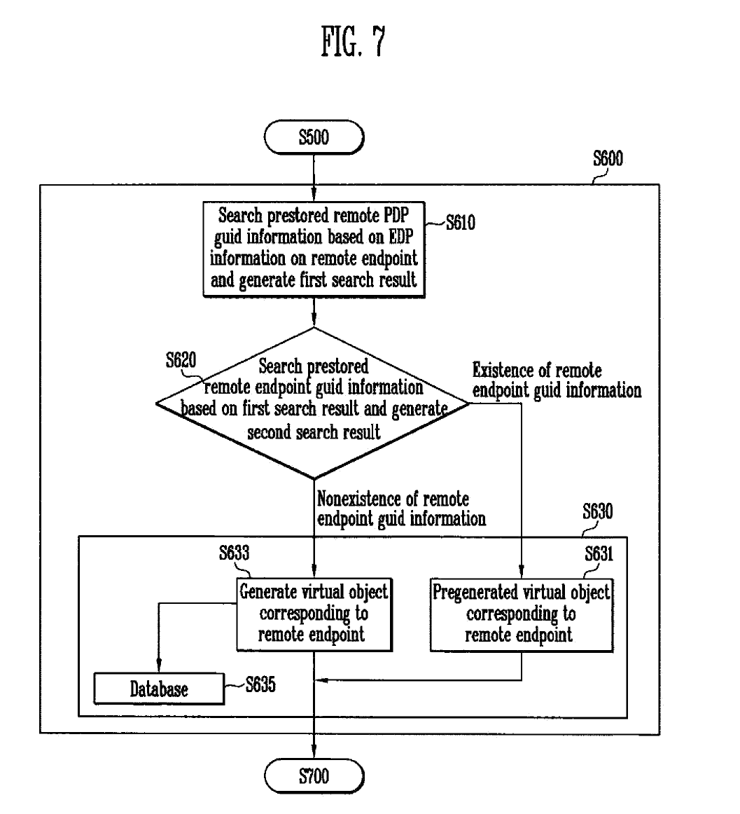

FIG. 6 is a flowchart illustrating a process of performing DDS communication through generating a virtual object in multiple network domains according to an embodiment of the present invention.

Referring to FIG. 6, a process of performing DDS communication through generating a virtual object in multiple network domains according to an embodiment of the present invention may include receiving EDP information on a remote Endpoint (S500), generating a virtual object corresponding to the remote Endpoint (S600), and performing DDS communication between the virtual object corresponding to the remote Endpoint and an Endpoint (S700).

First of all, an access may be made between DDS routers that are separated physically and logically (S300).

Then, PDP information and EDP information may be exchanged between the DDS routers (S400). Herein, the process of exchanging the PDP information and EDP information was explained with reference to FIG. 4 and thus is omitted for simplicity of explanation.

Then, EDP information on a remote Endpoint may be received from a remote network domain that is separated physically or logically (S500).

Then, a virtual object corresponding to the remote Endpoint may be generated by matching the EDP information on the remote Endpoint and information included in the remote network domain prestored in the database (S600).

Herein, the information included in the remote network domain may include PDP information and EDP information on the remote network domain. More specifically, the information included in the remote network domain may include PDP GUID information and Endpoint GUID information on the remote network domain.

Herein, the virtual object corresponding to the remote Endpoint may be the virtual object of the remote Endpoint that shares a same topic with an Endpoint of a DDS, and the virtual object corresponding to the Endpoint may be the virtual object of the Endpoint that shares a same topic with a remote Endpoint of a remote DDS. That is, a virtual object that may be generated is only one that corresponds to a remote Endpoint that requires DDS communication with an Endpoint of the DDS 100 or one that corresponds to an Endpoint that requires DDS communication with a remote Endpoint.

Then, DDS communication may be made between the virtual object corresponding to the remote Endpoint and an Endpoint of the network domain (S700).

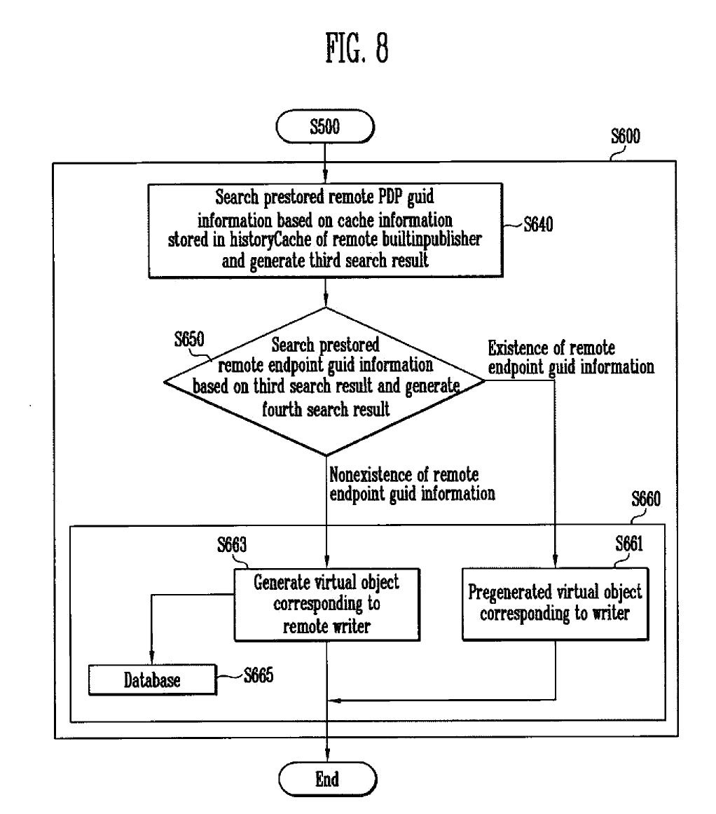

FIG. 7 is a flowchart illustrating a process of generating a virtual object corresponding to a remote Endpoint in multiple network domains according to an embodiment of the present invention.

Referring to FIG. 7, a process of generating a virtual object corresponding to a remote Endpoint according to an embodiment of the present invention may receive EDP information on a remote Endpoint (S500).

Then, PDP GUID information on a remote network domain prestored in a database is searched based on the EDP information on the remote Endpoint, and a first search result may be generated according to a result of the search (S610).

Then, Endpoint GUID information on the remote network domain prestored in the database may be searched based on the first search result, and a second search result may be generated according to a result of the search (S620).

Then, a virtual object corresponding to the remote Endpoint may be generated according to the second search result (S630).

Herein, when Endpoint GUM information on the remote network domain exists in the database, a virtual object corresponding to the remote Endpoint pregenerated and prestored in the database may be used (S631).

Herein, when Endpoint GUID information on the remote network domain does not exist in the database, a virtual object corresponding to the remote Endpoint may be generated (S633). Then, information on the generated virtual object corresponding to the remote Endpoint may be stored in the database (S635).

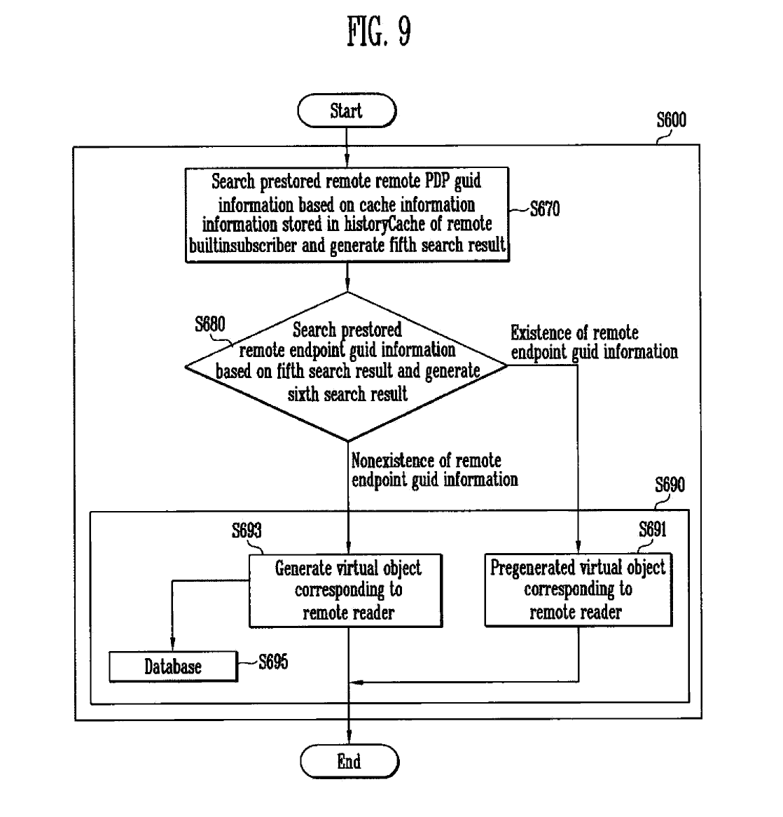

FIG. 8 is a flowchart illustrating a process of generating a virtual object corresponding to a remote writer in multiple network domains according to an embodiment of the present invention.

Referring to FIG. 8, a process of generating a virtual object corresponding to a remote writer in multiple network domains according to an embodiment of the present invention may receive EDP information on a remote Endpoint (S500).

Herein, the EDP information on the remote Endpoint may be cache information stored in a HistoryCache of a remote BuiltinPublisher of a remote network domain.

Then, PDP GUID information on the remote network domain prestored in a database may be searched based on the cache information stored in the HistoryCache of the remote BuiltinPublisher of the remote network domain, and a third search result may be generated based on a result of the search (S640).

Then, Endpoint GUID information on the remote network domain prestored in the database may be searched based on the third search result, and a fourth search result may be generated based on a result of the search (S650).

Then, a virtual object corresponding to a remote Writer may be generated according to the fourth search result (S660).

Herein, when Endpoint GUID information on the remote network domain exists in the database, a virtual object of the remote Writer pregenerated and prestored in the database may be used (S661).

Herein, when Endpoint GUID information on the remote network domain does not exist in the database, a virtual object corresponding to the remote Writer may be generated (S663). Then, information on the generated virtual object corresponding to the remote Writer may be stored in the database (S665).

Then, the virtual object corresponding to the remote Writer and cache information stored in the HistoryCache of the BuiltinSubscriber of itself may be compared, and matching subscriber information may be connected.

FIG. 9 is a flowchart illustrating a process of generating a virtual object corresponding to a remote Reader in multiple network domains according to an embodiment of the present invention.

Referring to FIG. 9, a process of generating a virtual object corresponding to a remote Reader in multiple network domains according to an embodiment of the present invention may receive EDP information on a remote Endpoint (S500).

Herein, EDP information on the remote Endpoint may be cache information stored in a HistoryCache of a remote BuiltinSubscriber of a remote network domain.

Then, PDP GUID information on the remote network domain prestored in a database may be searched based on the cache information stored in the HistoryCache of the remote BuiltinSubscriber, and a fifth search result may be generated according to a result of the search (S670).

Then, Endpoint GUID information on the remote network domain prestored in the database may be searched based on the fifth search result, and a sixth search result may be generated based on a result of the search (S680).

Then, a virtual object corresponding to the remote Reader may be generated according to the sixth search result (S690).

Herein, when Endpoint GUID information on the remote network domain exists in the database, a virtual object corresponding to the remote Reader pregenerated and prestored in the database may be used (S691).

Herein, when Endpoint GUID information on the remote network domain does not exist in the database, a virtual object corresponding to the remote Reader may be generated (S693). Then information on the generated virtual object corresponding to the remote Reader may be stored in the database (S695).

Then, the virtual object corresponding to the remote Reader and cache information stored in a HistoryCache of a BuiltinPublisher of itself may be compared, and a connection to matching publisher information may be made.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A virtual object generating apparatus for DDS (Data Distribution Service) communication in multiple network domains, the apparatus comprising:
a communicator for receiving EDP (Endpoint Discovery Protocol) information on a remote Endpoint from a remote network domain separated physically or logically; and
a virtual object generator for matching the EDP information on the remote Endpoint and information included in the remote network domain prestored in a database, and for generating a virtual object corresponding to the remote Endpoint.

2. The apparatus according to claim 1,
wherein the information included in the remote network domain comprises PDP (Participant Discovery Protocol) GUID (Globally Unique Identifier) information and Endpoint GUID information on the remote network domain.

3. The apparatus according to claim 2, wherein the virtual object generator searches the PDP GUID information based on the EDP information on the remote Endpoint, searches the Endpoint GUID information based on a result of the search and generates a virtual object corresponding to the remote endpoint.

4. The apparatus according to claim 3,
wherein the virtual object generator generates a virtual object corresponding to a remote Writer of the remote network domain, when the EDP information on the remote Endpoint is cache information stored in a HistoryCache of a remote BuiltinPublisher of the remote network domain.

5. The apparatus according to claim 3,
wherein the virtual object generator generates a virtual object corresponding to a remote Reader of the remote network domain, when the EDP information on the remote Endpoint is cache information stored in a HistoryCache of a remote BuiltinSubscriber of the remote network domain.

6. The apparatus according to claim 1,
wherein the virtual object corresponding to the remote Endpoint is a virtual object of the remote Endpoint that shares a same topic with an endpoint of a DDS.

7. A virtual object generating method for DDS (Data Distribution Service) communication in multiple network domains, the method comprising:
receiving EDP (Endpoint Discovery Protocol) information on a remote Endpoint from a remote network domain separated physically or logically; and
matching the EDP information on the remote Endpoint and information included in the remote network domain prestored in a database, and generating a virtual object corresponding to the remote Endpoint.

8. The method according to claim 7,
wherein the information included in the remote network domain comprises PDP (Participant Discovery Protocol) GUID (Globally Unique Identifier) information and Endpoint GUID information on the remote network domain.

9. The method according to claim 8,
wherein the generating a virtual object corresponding to the remote endpoint searches the PDP GUID information based on the EDP information on the remote Endpoint, searches the Endpoint GUID information based on a result of the search, and generates a virtual object corresponding to the remote Endpoint.

10. The method according to claim 9,
wherein the generating a virtual object corresponding to the remote Endpoint generates a virtual object corresponding to a remote Writer of the remote network domain, when the EDP information on the remote Endpoint is cache information stored in a HistoryCache of a remote BuiltinPublisher of the remote network domain.

11. The method according to claim 9,
wherein the generating a virtual object corresponding to the remote Endpoint generates a virtual object corresponding to a remote Reader of the remote network domain, when the EDP information on the remote Endpoint is cache information stored in a HistoryCache of a remote BuiltinSubscriber of the remote network domain.

12. The method according to claim 7,
wherein the virtual object corresponding to the remote Endpoint is a virtual object of the remote Endpoint that shares a same topic with an endpoint of a DDS.
